(19) United States
(12) Patent Application Publication
(10) Pub. No.: US 2024/0238971 A1
(43) Pub. Date: Jul. 18, 2024

(54) METHOD AND SYSTEM FOR CARRYING OUT A ROBOT APPLICATION

(71) Applicants: KUKA Deutschland GmbH, Augsburg (DE); KUKA AKTIENGESELLSCHAFT, Augsburg (DE)

(72) Inventors: Uwe Bonin, Augsburg (DE); André Hetzke, Dachau (DE)

(73) Assignees: KUKA Deutschland GmbH, Augsburg (DE); KUKA AG, Augsburg (DE)

(21) Appl. No.: 18/557,717

(22) PCT Filed: Mar. 22, 2022
(86) PCT No.: PCT/EP2022/057435

§ 371 Date: Nov. 9, 2023

(30) Foreign Application Priority Data
Apr. 29, 2021 (DE) 10 2021 204 306.2

(51) Int. Cl. B25J 9/16

(52) U.S. Cl. CPC B25J 9/1664

(57) ABSTRACT

A method for carrying out a robot application includes controlling the robot to: carry out a transfer movement in a set-up operation, in which the robot speed reaches a set-up transfer movement top speed; carry out a process movement in the set-up operation, in which the robot speed reaches a set-up process movement top speed; carry out the transfer movement in an automatic operation, in which the robot speed reaches an automatic transfer movement top speed; and carry out the process movement in the automatic operation, in which the robot speed reaches an automatic process movement top speed.

### CROSS-REFERENCE TO RELATED APPLICATIONS

This application is a national phase application under 35 U.S.C. § 371 of International Patent Application No. PCT/EP2022/057435, filed Mar. 22, 2022 (pending), which claims the benefit of priority to German Patent Application No. DE 10 2021 204 306.2, filed Apr. 29, 2021, the disclosures of which are incorporated by reference herein in their entirety.

### TECHNICAL FIELD

The present invention relates to a method for carrying out a robot application, as well as to a system and a computer program or computer program product for carrying out the method.

### BACKGROUND

Robot applications are often intended to be carried out in automatic operation at high robot speeds.

Accordingly, it is often prohibited for people to be in the vicinity of the robot, and safety measures such as protective fences or the like are sometimes provided for this purpose.

However, in order to set up such robot applications in the set-up operation, it is partly advantageous if a person can observe a process of the application from close range.

For this purpose, it is known from internal practice to provide (low(er)) speed limits in the set-up operation, which preferably enable a person to still react even in the event of a malfunction of the robot, for example the so-called set-up operating mode T1 (“manual at reduced speed”).

Disadvantageously, processes such as, for example, overgrinding when traveling along process paths or the like can only be tested or evaluated to a limited extent at such reduced speeds.

### SUMMARY

The object of the present invention is to improve carrying out robotic applications.

This object is achieved by a method, a system, and a computer program or computer program product for carrying out a method as described herein.

According to one embodiment of the present invention, a method for carrying out a robot application comprises a set-up operation in which, in one embodiment, the robot application is carried out completely or partially, in one embodiment is tested and/or modified, and a subsequent automatic operation in which, in one embodiment, the robot application is carried out one or more times, in one embodiment in order to handle and/or machine workpieces. In the set-up operation, the robot application can be carried out, in one embodiment, without handling and/or processing workpieces.

According to one embodiment of the present invention, the robot application comprises at least one process movement of a robot and at least one transfer movement of the robot which, in one embodiment, precedes, in one embodiment immediately precedes, the process movement, or follows, in one embodiment immediately follows, the process movement. In one embodiment, the robot handles and/or processes at least one workpiece in the automatic operation during the process movement. Additionally or alternatively, in one embodiment, a tool of the robot is deactivated in the automatic operation during the transfer movement and/or a gripper of the robot is empty.

According to one embodiment of the present invention, the robot is controlled so as to carry out the process movement in the set-up operation, wherein a robot speed reaches a top speed (value), which is referred to herein without limitation of generality as the set-up process movement top speed (value). In one embodiment, the robot is controlled accordingly or the set-up process movement top speed is commanded at least temporarily.

A robot speed referred to herein is, in one embodiment, a speed of a reference point of the robot, in one embodiment of the TCP, of a point of a robot element, preferably of an end flange or end effector, of the robot, in one embodiment of a stationary point or of the point of the robot that has the highest speed. In another embodiment, a robot speed referred to herein is an axis speed of one or more (movement) axes of the robot.

According to one embodiment of the present invention, the robot is controlled so as to carry out the transfer movement in the set-up operation, wherein the robot speed reaches a top speed (value), which is referred to herein without limitation of generality as the set-up transfer movement top speed (value). In one embodiment, the robot is controlled accordingly or the set-up transfer movement top speed is commanded at least temporarily.

According to one embodiment of the present invention, the robot, in particular after the set-up operation, is controlled so as to carry out the process movement in the automatic operation, wherein the robot speed reaches a top speed (value), which is referred to herein without limitation of generality as the automatic process movement top speed (value). In one embodiment, the robot is controlled accordingly or the automatic process movement top speed is commanded at least temporarily.

According to one embodiment of the present invention, the robot is controlled so as to carry out the transfer movement in the automatic operation, wherein the robot speed reaches a top speed (value) which is referred to herein without limitation of generality as the automatic transfer movement top speed (value). In one embodiment, the robot is controlled accordingly or the automatic transfer movement top speed is commanded at least temporarily.

In the present case, a top speed mentioned herein is in particular understood to mean the maximum speed (value) which the robot speed reaches at least temporarily (during, in particular due to, the corresponding control).

One embodiment of the present invention is based on the following basic concept:

In order to be able to (better) evaluate or test the carrying out of the process movement, it should be carried out in the set-up operation at a robot speed which comes close, preferably as closely as possible, to the (usually high) robot speed in the automatic operation and which corresponds to this in one embodiment.

On the other hand, this is usually not required for transfer movements.

At the same time, however, such transfer movements are often more long-range and/or more difficult for people to assess and/or faster in the automatic operation than process movements.

Therefore, in one embodiment, it is proposed to restrict the robot speed for one or more transfer movements in the set-up operation and, in contrast, not to restrict said speed or to restrict it to a lesser degree for one or more process movements.

In this way, carrying out the process movement(s) can be (better) evaluated or tested in the set-up operation, and at the same time a person in the vicinity of the robot application can be better protected due to the limited speed of the transfer movement(s).

According to one embodiment of the present invention, the robot is therefore controlled such, in particular with the proviso that, the set-up transfer movement top speed is, in particular is being, reduced compared to the automatic transfer movement top speed, and the set-up process movement top speed is not, or is not being, reduced compared to the automatic process movement top speed, or is, or is being, reduced to a lesser (less severe) degree than the set-up transfer movement top speed compared to the automatic transfer movement top speed.

For this purpose, in one embodiment, a scaling factor for a commanded speed of the robot for carrying out the transfer movement in the set-up operation is reduced, preferably automatically, in one embodiment by or to a predetermined factor, and compared thereto the scaling factor for a commanded speed of the robot for carrying out the process movement in the set-up operation is not reduced or, preferably automatically, is reduced to a lesser degree.

In this way, in one embodiment—due to the (more severely) reduced set-up transfer movement top speed compared to the automatic transfer movement top speed—the safety can be increased and nevertheless—due to the not or to a lesser degree reduced set-up process movement top speed—the carrying out of the process movement can be better tested or evaluated.

In addition or alternatively to this aspect of the (more severely) reduced set-up transfer movement top speed, according to one embodiment of the present invention, an error response is triggered if, while the robot is being controlled so as to carry out the transfer movement in the set-up operation, the robot speed exceeds an upper set-up transfer movement speed threshold outside a process space, the exceeding of which upper set-up transfer movement speed threshold within the process space while the robot is being controlled so as to carry out the process movement in the set-up operation is permissible or does not lead to the error response being triggered, in one embodiment said threshold being exceeded at least temporarily while the robot is being controlled so as to carry out the process movement in the set-up operation within the process space.

In one embodiment, a process space referred to herein is a space that is delimited by a limit, in particular a limit that is predetermined programmatically, and that, in one embodiment, is, or in particular is being, provided or predetermined for carrying out the process movement. In one embodiment, it is a Cartesian space or limited partial space of a working space of the robot within which a, in particular the, reference point of the robot, in one embodiment of the TCP, a point of a robot element, preferably an end flange or end effector, of the robot, in one embodiment a stationary point, is allowed to move for or while carrying out the process movement, preferably including a predefined tolerance range about the process movement (predetermined programmatically). In one embodiment, a process space referred to here is an axis space of one or more (movement) axes of the robot, within which the axis (axes) may shift for or while carrying out the process movement, its limit corresponding to one or more axis limits(s) predetermined in particular programmatically.

In one embodiment, an error response, in one embodiment the same error response, is (also) triggered if, while the robot is being controlled so as to carry out the process movement in the set-up operation, the robot, in particular its reference point or its axis (axes), exceeds a limit or the limit of the process space, or the process space is exited.

One embodiment of this aspect is based on the following concept:

At least within the process space, which is or is being provided or predetermined for carrying out the process movement, in particular as long as it is or is being ensured by monitoring that this is not being exited or is not exited, in particular by the reference point or the axis (axes), or otherwise that an error response is triggered, the process movement can be carried out or allowed to be carried out at a high or respectively higher speed.

In any case, when carrying out the transfer movement in the set-up operation outside the process space, the robot speed, however, is to be limited or is limited, in particular, to a predefined or set, in one embodiment programmatically predefined or set, upper set-up transfer speed threshold; this is to be or is ensured, in particular by monitoring, such that, in any case, if (it is determined that), while the robot is being controlled so as to carry out the transfer movement in the set-up operation, the process space is or is being exited, in particular by the reference point or the axis (axes), or its limit is or is being exceeded, safety is intended to be increased by the low(er) speed provided for carrying out the transfer movement, particularly when outside the process space the high or higher speed is not required for set-up.

In one embodiment, during the set-up operation, at least one person is allowed to be present at least temporarily in a working region of the robot, in one embodiment of a, preferably fenced, cell of the robot and/or within reach of the robot, or this is permitted; in a further development, during the set-up operation, at least one person is present at least temporarily in a working region of the robot, in one embodiment of a, preferably fenced, cell of the robot and/or within reach of the robot, which person, in one embodiment, observes, evaluates and/or modifies the robot application and/or temporarily stops the robot application one or more times. In one embodiment, the robot application is set up during and/or after the set-up operation, in particular on the basis of the process and/or transfer movement carried out in this case, and in one embodiment the robot application, in particular the process and/or the transfer movement, is tested, observed, evaluated, temporarily stopped and/or modified. As a result, in one embodiment, the subsequent automatic operation can be improved, in particular reliability and/or accuracy can be increased and/or set-up time can be reduced. In one embodiment, in the automatic operation, the robot application or its process and transfer movement that was set up during and/or after the set-up operation, i.e. in particular tested, observed, evaluated, temporarily stopped and/or modified, is carried out.

In one embodiment, an error response is triggered if, while the robot is being controlled so as to carry out the process movement in the set-up operation, a consent to be effected by the person, in a further development by actuating a, preferably at least three-stage, consent switch, is not present.

Additionally or alternatively, in one embodiment, an error response is triggered if, while the robot is being controlled so as to carry out the transfer movement in the set-up operation, a consent to be effected by the person, in a further development by actuating a, preferably at least three-stage, consent switch, is not present.

As a result, in one embodiment the safety can be (further) increased.

In one embodiment, the robot has at least three, in particular at least six, in one embodiment at least seven, joints or movement axes and/or at least one robot arm having at least three, in particular at least six, in one embodiment at least seven, joints or movement axes; in one embodiment it is an industrial robot. With these, the setting up is particularly important.

An error response mentioned herein comprises, in one embodiment, a stop or halt of the robot, in one embodiment of the robot application. As a result, in one embodiment the safety can be (further) increased.

In one embodiment, the set-up process movement top speed and/or set-up transfer movement top speed and/or automatic process movement top speed and/or automatic transfer movement top speed and/or the reduction of the set-up process movement top speed and/or set-up transfer movement top speed and/or automatic process movement top speed and/or automatic transfer movement top speed is, in particular is being, predetermined programmatically and/or automatically.

Additionally or alternatively, in one embodiment, the process space is, in particular is being, predetermined, in particular programmatically and/or automatically, for the robot, in particular its reference point or its axis (axes), in a predetermined based on the process movement. For example, it may be or become predefined, by or as a Cartesian space of the reference point or a range of the adjustment range of one or more (movement) axes of the robot, wherein, in one embodiment, within the process space means that the reference point is within this Cartesian space or its limit or the axis position(s) is/are within this adjustment range, outside of the process space correspondingly means that the reference point is outside this Cartesian space or its limit or the axis position(s) is/are outside this adjustment range, and the robot exceeds one or the limit of the process space when the reference point exceeds the limit of this Cartesian space or the axial position(s) exceed/exceeds the limit of the adjustment range.

As a result, in one embodiment, safety can be (further) increased and/or the setting up can be improved, in particular reliability and/or accuracy can be increased and/or a set-up time can be reduced.

According to one embodiment of the present invention, a system is configured, in particular in terms of hardware and/or software, for carrying out a method described herein and/or comprises:
means for controlling the robot so as to carry out the transfer movement in a set-up operation, wherein, in particular such that, the robot speed reaches a set-up transfer movement top speed;
means for controlling the robot so as to carry out the process movement in the set-up operation, wherein, in particular such that, a robot speed reaches a set-up process movement top speed;
means for controlling the robot so as to carry out the transfer movement in an automatic operation, wherein, in particular such that, the robot speed reaches an automatic transfer movement top speed;
and means for controlling the robot so as to carry out the process movement in the automatic operation, wherein, in particular such that, the robot speed reaches an automatic process movement top speed;
as well as
means for controlling the robot such that the set-up transfer movement top speed is reduced compared to the automatic transfer movement top speed and the set-up process movement top speed is not reduced compared to the automatic process movement top speed or is reduced to a lesser degree than the set-up transfer movement top speed compared to the automatic transfer movement top speed; and/or
means for triggering an error response if, while the robot is being controlled so as to carry out the transfer movement in the set-up operation, the robot speed exceeds an upper set-up transfer movement speed threshold outside a process space, said upper set-up transfer movement speed threshold being exceedable, in particular being exceeded, within the process space while the robot is being controlled so as to carry out the process movement in the set-up operation.

In one embodiment, the system comprises: means for triggering an error response if, while the robot is being controlled so as to carry out the process movement in the set-up operation, the robot exceeds a limit of the process space.

In one embodiment, the system comprises: means for temporarily stopping and/or modifying the robot application by a person who, during the set-up operation, is allowed to be, in particular is present, at least temporarily in a working region, in particular a cell and/or within reach, of the robot.

In one embodiment, the system comprises: means for triggering an error response if, while the robot is being controlled so as to carry out the process movement in the set-up operation, a consent to be effected by the person, in particular by actuating a consent switch, is not present, and/or means for triggering an error response if, while the robot is being controlled so as to carry out the transfer movement in the set-up operation, a consent to be effected by the person, in particular by actuating a consent switch, is not present.

A system and/or means in the sense of the present invention may be designed in terms of hardware and/or software, in particular having at least one processing unit, in particular a digital processing unit, in particular a microprocessor unit (CPU), graphics card (GPU) or the like, which is preferably connected to a storage and/or bus system in terms of data or signals, and/or having one or more programs or program modules. The processing unit may be designed to process commands that are implemented as a program stored in a storage system, to detect input signals from a data bus and/or to output signals to a data bus. A storage system may comprise one or a plurality of, in particular different, storage media, in particular optical, magnetic, solid-state, and/or other non-volatile media. The program may be of such a nature that it embodies or is capable of carrying out the methods described herein, so that the processing unit is able to carry out the steps of such methods and thus, in particular, is able to carry out the robot application or is able to operate or control the robot.

In one embodiment, a computer program product may comprise, in particular be, a storage medium, in particular a computer-readable and/or non-volatile storage medium, for storing a program or instructions or having a program or instructions stored thereon. In one embodiment, executing this program or these instructions by means of a system or controller, in particular a computer or an arrangement of a plurality of computers, causes the system or controller, in particular the computer or computers, to carry out a method described herein or one or more of its steps, or the program or instructions are set up for this purpose.

In one embodiment, one or more, in particular all, steps of the method are performed completely or partially automatically, in particular by the system or its means.

In one embodiment, the system comprises the robot.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 schematically depicts a system according to an embodiment of the present invention; and

FIG. 2 is a flowchart depicting a method according to an embodiment of the present invention.

### DETAILED DESCRIPTION

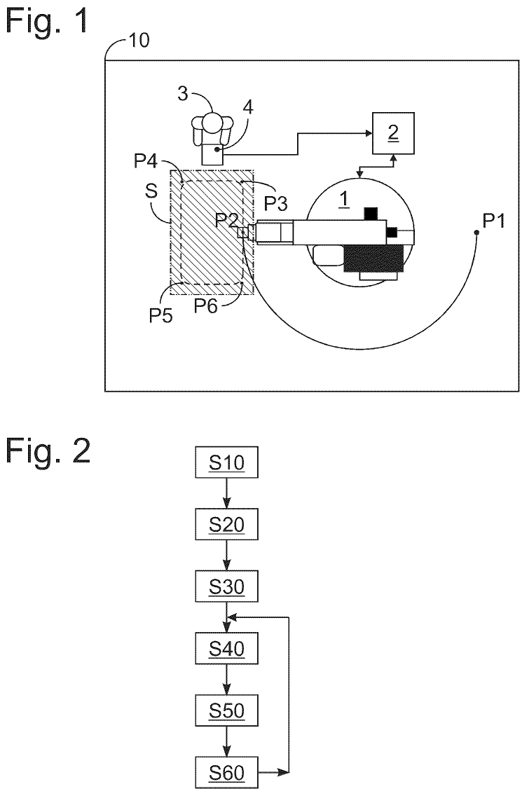

FIG. 1 shows a robot 1, which is intended to carry out a robot application which comprises a process movement in the form of traveling along the process path predetermined by points P2→P6 while overgrinding, a preceding transfer movement from a point P1 to point P2, and a subsequent transfer movement from point P2 back to point P1.

A limited process space S, which is indicated by hatching in FIG. 1, is predetermined for or by the process.

To set up the robot application, a person 3 with a hand-held device comprising a consent switch 4 stands near the process path P3-P6 within a fenced robot cell 10 within reach of the robot 1.

The hand-held device comprising a consent switch 4 and the robot 1 are signal-connected to a robot controller 2.

In a step S10 (cf. FIG. 2), the robot 1 is first controlled so as to carry out the transfer movement P1→P2 in a set-up operation, wherein the TCP of the robot reaches a low (set-up transfer movement) top speed of preferably less than 250 mm/s, and this or respectively (the compliance with) a set-up transfer movement speed threshold of preferably 250 mm/s is monitored at least as long as the TCP is (still) outside the process space S, in one embodiment also until the point P2 is reached. Similarly, monitoring can also be terminated or the upper speed threshold and/or robot speed can also be increased when the robot enters the process space S.

In a subsequent step S20, the robot 1 is controlled so as to travel along the process path P2→P3→P4→P5→P6→P2 in the set-up operation, wherein the TCP of the robot reaches a (set-up process movement) top speed of, for example, 400 mm/s, which corresponds to a commanded or predetermined top speed in the automatic operation, and it is monitored that the TCP during this is in the process space S.

In this case, the person 3 observes this traveling and can evaluate the application and/or temporarily stop and/or modify it several times if necessary.

In a subsequent step S30, the robot 1 is controlled so as to carry out the transfer movement P2→P1 in the set-up operation, wherein the TCP of the robot again reaches a low(er) (set-up transfer movement) top speed of preferably less than 250 mm/S, and this or respectively (the compliance with) a set-up transfer movement speed threshold of preferably 250 mm/s is at least monitored as soon as the TCP is not (any longer) in the process space S.

In a subsequent step S40, the robot 1 is again controlled so as to carry out the transfer movement P1→P2 in an automatic operation, wherein the TCP of the robot now reaches a high or higher (automatic transfer movement) top speed of, for example, more than 500 mm/s.

In a subsequent step S50, the robot 1 is controlled so as to travel along the process path P2→P3→P4→P5→P6→P2 in the automatic operation, wherein, as in the set-up operation, the TCP of the robot reaches a top speed of, for example, 400 mm/s.

In a subsequent step S60, the robot 1 is controlled so as to carry out the transfer movement P2→P1 in the automatic operation, wherein the TCP of the robot reaches a high or higher (automatic transfer movement) top speed of, for example, 500 mm/s.

The person 3 is inside the cell 10 during the set-up operation, and outside during the automatic operation. If, during the set-up operation, the person releases the three-stage consent switch 4 completely or presses it all the way, a safety stop of the robot 1 is triggered.

Likewise, a safety stop of robot 1 is also triggered if, in the set-up operation, the TCP leaves the process space S while robot 1 is being controlled so as to travel along the process path (S20).

Likewise, a safety stop of the robot 1 is also triggered if, in the set-up operation, the TCP outside the process space S exceeds the upper set-up transfer movement speed threshold, while the robot 1 is being controlled so as to carry out the transfer movement (S10, S30). As explained above, in one embodiment, the safety stop of the robot 1 may also be triggered if, in the set-up operation, the TCP within the process space S exceeds the upper set-up transfer movement speed threshold, while the robot 1 is being controlled so as to carry out the transfer movement (S10, S30). Likewise, in this case, the triggering of the safety stop can also be omitted in one embodiment.

Although exemplary embodiments have been explained in the preceding description, it is noted that a large number of modifications are possible. It is also noted that the exemplary embodiments are merely examples that are not intended to restrict the scope of protection, the applications and the structure in any way. Rather, the preceding description provides a person skilled in the art with guidelines for implementing at least one exemplary embodiment, with various changes, in particular with regard to the function and arrangement of the described components, being able to be made without departing from the scope of protection as it arises from the claims and from these equivalent combinations of features.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

List of reference signs

| | |
|---|---|
| 1 | robot |
| 2 | robot controller |
| 3 | (operating) person |
| 4 | consent switch |
| 10 | cell |
| P1, . . . , P6 | point of the process/transfer movement |
| S | process space |

What is claimed is:

1-6. (canceled)

7. A method for carrying out a robot application that includes at least one process movement and at least one transfer movement of the robot, the method comprising:
controlling the robot to carry out the transfer movement in a set-up operation, wherein the robot speed reaches a set-up transfer movement top speed;
controlling the robot to carry out the process movement in the set-up operation, wherein the robot speed reaches a set-up process movement top speed;
controlling the robot to carry out the transfer movement in an automatic operation, wherein the robot speed reaches an automatic transfer movement top speed; and
controlling the robot to carry out the process movement in the automatic operation, wherein the robot speed reaches an automatic process movement top speed;
wherein at least one of:
the robot is controlled such that: a) the set-up transfer movement top speed is reduced compared to the automatic transfer movement top speed, and b) the set-up process movement top speed is not reduced compared to the automatic process movement top speed, or is reduced to a lesser degree than the set-up transfer movement top speed compared to the automatic transfer movement top speed, or
an error response is triggered if, while the robot is being controlled to carry out the transfer movement in the set-up operation, the robot speed outside a process space exceeds an upper set-up transfer movement speed threshold, wherein the upper set-up transfer movement speed threshold may be exceeded within the process space while the robot is being controlled to carry out the process movement in the set-up operation.

8. The method of claim 7, further comprising:
triggering an error response in response to the robot exceeding a limit of the process space while the robot is being controlled to carry out the process movement in the set-up operation.

9. The method of claim 7, further comprising:
at least one of observing or evaluating the robot application during the set-up operation by at least one person that is present, at least temporarily, in at least one of a working region of the robot, a cell of the robot, or a space within reach of the robot; and
at least one of temporarily stopping the robot application or modifying the robot application by the at least one person.

10. The method of claim 9, further comprising triggering an error response in response to at least one of:
a consent to be effected by the person is not present while the robot is being controlled to carry out the process movement in the set-up operation; or
a consent to be effected by the person is not present while the robot is being controlled to carry out the transfer movement in the set-up operation.

11. The method of claim 10, wherein the consent to be effected by the person comprises actuating a consent switch.

12. A system for carrying out a robot application that includes at least one process movement and at least one transfer movement of the robot, the system comprising:
means for controlling the robot to carry out the transfer movement in a set-up operation, wherein the robot speed reaches a set-up transfer movement top speed;
means for controlling the robot to carry out the process movement in the set-up operation, wherein the robot speed reaches a set-up process movement top speed;
means for controlling the robot to carry out the transfer movement in an automatic operation, wherein the robot speed reaches an automatic transfer movement top speed; and
means for controlling the robot to carry out the process movement in the automatic operation, wherein the robot speed reaches an automatic process movement top speed;
wherein at least one of:
the robot is controlled such that: a) the set-up transfer movement top speed is reduced compared to the automatic transfer movement top speed, and b) the set-up process movement top speed is not reduced compared to the automatic process movement top speed, or is reduced to a lesser degree than the set-up transfer movement top speed compared to the automatic transfer movement top speed, or
an error response is triggered if, while the robot is being controlled to carry out the transfer movement in the set-up operation, the robot speed outside a process space exceeds an upper set-up transfer movement speed threshold, wherein the upper set-up transfer movement speed threshold may be exceeded within the process space while the robot is being controlled to carry out the process movement in the set-up operation.

13. A computer program product having program code stored on a non-transitory, computer-readable medium, the program code configured to, when executed by one or more computers, cause the one or more computers to carry out the method of claim 7.
